(19) United States
(12) Patent Application Publication
(10) Pub. No.: US 2007/0142061 A1
(43) Pub. Date: Jun. 21, 2007

(54) Method and apparatus for determining the location of a node in a wireless network

(76) Inventors: David B. Taubenheim, Plantation, FL (US); Spyros Kyperountas, Weston, FL (US)

Correspondence Address: MOTOROLA, INC., 1303 EAST ALGONQUIN ROAD, IL01/3RD, SCHAUMBURG, IL, 60196, US

(21) Appl. No.: 11/312,203

(22) Filed: Dec. 20, 2005

(51) Int. Cl. H04Q 7/20

(52) U.S. Cl. 455/456.2

(57) ABSTRACT

A method and apparatus for determining the location of a node within a communication system is provided herein. During operation, located nodes (105) having known locations are utilized to locate “blind” nodes (200) whose location is to be determined. More particularly, a blind node (200) wishing to determine its location will measure a plurality of signal strengths between itself and a plurality of located nodes (105). Each located node's signal strength will then be adjusted based on at least one antenna gain pattern. A radio-location algorithm will then be executed on the adjusted signal-strength measurements to determine the nodes location.

### FIELD OF THE INVENTION

The present invention relates generally to radiolocation and in particular, to a method and apparatus for determining the location of a node within a wireless network.

### BACKGROUND OF THE INVENTION

The accuracy of radiolocation systems based on signal-strength measurements is best when an isotropic (non-directional) composite antenna radiation pattern exists for both the transmitter and the receiver. Unfortunately, the non-isotropic (directional) characteristic of wireless nodes with inexpensive integrated antennas, such as those for IEEE 802.15.4 or Zigbee, is a problem that is practically impossible to avoid. Because of this, the accuracy of location estimates provided by a signal-strength-based radiolocation system often suffers. Therefore, a need exists for a method and apparatus for determining the location of a node within a wireless communication system that accounts for the non-isotropic characteristics of wireless nodes' antennas.

### BRIEF DESCRIPTION OF THE DRAWINGS

FIG. 1 is illustrates a typical floor plan of an office building in which are located a number of wireless devices involved in determining each other's location.

FIG. 2 shows a composite radiation pattern of a node.

FIG. 3 is a block diagram of a node equipped to determine its location via signal-strength measurements.

FIG. 4 is a flow chart showing operation of the node of FIG. 3.

### DETAILED DESCRIPTION OF THE DRAWINGS

In order to address the above-mentioned need, a method and apparatus for determining the location of an object within a wireless communication system is provided herein. During operation, “reference” nodes are utilized by “blind” nodes to determine their locations. “Reference” nodes are nodes having known locations, while “blind” nodes are nodes having unknown locations or otherwise wishing to determine their locations. A blind node wishing to determine its location will perform a plurality of signal-strength measurements between itself and a plurality of reference nodes. The signal strength of the reference node's signal, as measured by the blind node, will then be adjusted by the blind node based on at least one antenna gain pattern, in order to compensate for any directionality present in the antennas' radiation pattern. A radiolocation algorithm will then be executed, making use of the adjusted signal-strength measurements to determine a blind node's location.

In such systems, a “node” refers to radio device that is part of the wireless network. Nodes may be coupled to objects, such as inventory in a warehouse, so that the locations of the objects can be known. Of course, one of ordinary skill in the art will recognize that the location of a node may be determined either while the node is alone or while it is coupled to another object.

The present invention encompasses a method for determining a location of a node in a wireless network. The method comprises the steps of receiving a plurality of signals from located nodes, determining a plurality of signal strengths for the plurality of signals, correcting the plurality of signal strengths based on at least one radiation pattern, and locating the node based on the corrected signal strengths.

The present invention additionally encompasses a method for determining a location of a node in a wireless network. The method comprises the steps of receiving a plurality of signals from located nodes, determining a plurality of signal strengths for the plurality of signals, and calculating a location of the blind node based on the signal strengths for the plurality of signals. Angles to the located nodes are determined and the plurality of signal strengths are corrected based on at least one radiation pattern and the angles to the located nodes. Finally, the location of the blind node is recalculated based on the corrected signal strengths.

The present invention additionally encompasses an apparatus comprising a receiver receiving a plurality of signals from located nodes, and logic circuitry determining a plurality of signal strengths for the plurality of signals, correcting the plurality of signal strengths based on at least one radiation pattern, and locating a node based on the corrected signal strengths.

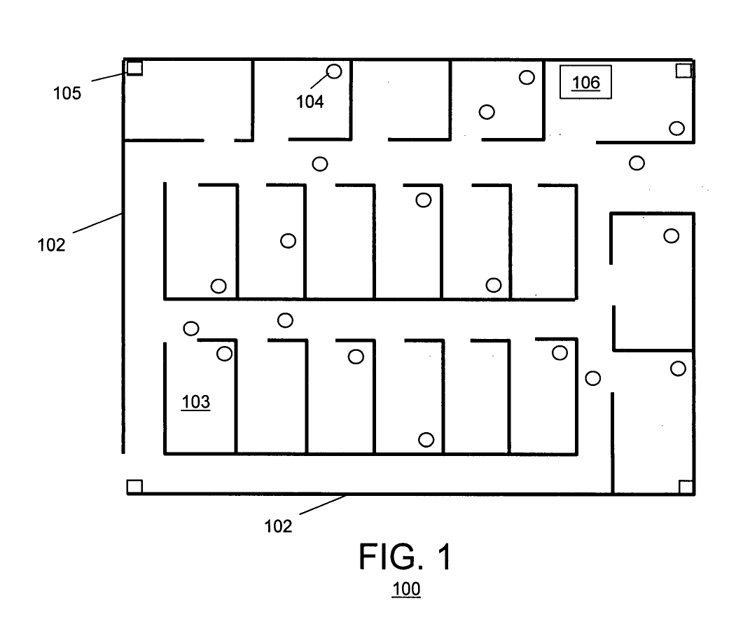

Turning now to the drawings, wherein like numerals designate like components, FIG. 1 is a block diagram of communication system 100 deployed over a floor plan of an interior of an office building. Communication system 100 comprises a number of wireless devices 104-106 involved in determining a particular node's location. The office building comprises perimeter wall 102 that encloses a plurality of offices 103 (only one labeled).

In the figure, circular objects, or nodes 104 (only one labeled), represent wireless devices, the locations of which are unknown and to be determined. Because the location of nodes 104 are unknown, these nodes 104 are referred to as “blind” nodes. Nodes 104 can include, for example, transceiver security tags attached to valuable assets such as lap top computers, or be embedded in wireless communication devices including cellular telephones.

Rectangular objects 105 (only one labeled) represent reference nodes in the figure. The locations of nodes 105 are known, or can be easily and accurately determined to within some measurement accuracy (e.g., via physical measurement). Reference nodes 105 are utilized in determining the locations of blind nodes 104. In a first embodiment of the present invention, all calculations involved in determining the location of a blind node take place within the blind node itself, however in an alternate embodiment, a processing node 106 serves as location-finding equipment (LFE) to perform calculations involved in determining the location of blind nodes 104.

It should be noted that although FIG. 1 shows nodes 104-106 existing within a two-dimensional space, one of ordinary skill in the art will recognize that nodes 104-106 may be located in other environments, including 3-dimensional spaces. For example, nodes 104 may comprise inventory located within a multi-level warehouse. Irrespective of the environment where nodes 104 operate, reference nodes 105 are dispersed in known locations to assist in locating blind nodes 104.

As described above, current signal strength based radiolocation algorithms, such as the ones expected to be used in Zigbee networks, assume that radiation patterns are isotropic, equally radiating and equally sensitive in all directions. Realistically, however, any directivity in the pattern biases the radiolocation algorithm by creating a false sense of closeness or distance in radiolocation ranging calculations. Applied to an entire network of wireless nodes, the effect of the directivity is compounded, resulting in systematic inaccuracy of location estimates.

Each node 104, 105 with non-isotropic antennas will have a transmitted signal strength and received signal sensitivity that varies by angle of transmission, where the angle of transmission comprises both an azimuth and a tilt. The non-isotropic characteristic of wireless nodes' antennas often leads to non-optimal location estimates. The composite radiation pattern of a wireless node results from both the overall physical design of a node and the design of its antenna. Such patterns apply to a node that is transmitting as well as receiving. While it is possible for the transmit and receive patterns to be different, in many designs of wireless nodes they are the same or similar, mainly because the transmit and receive antennas are one in the same or identical.

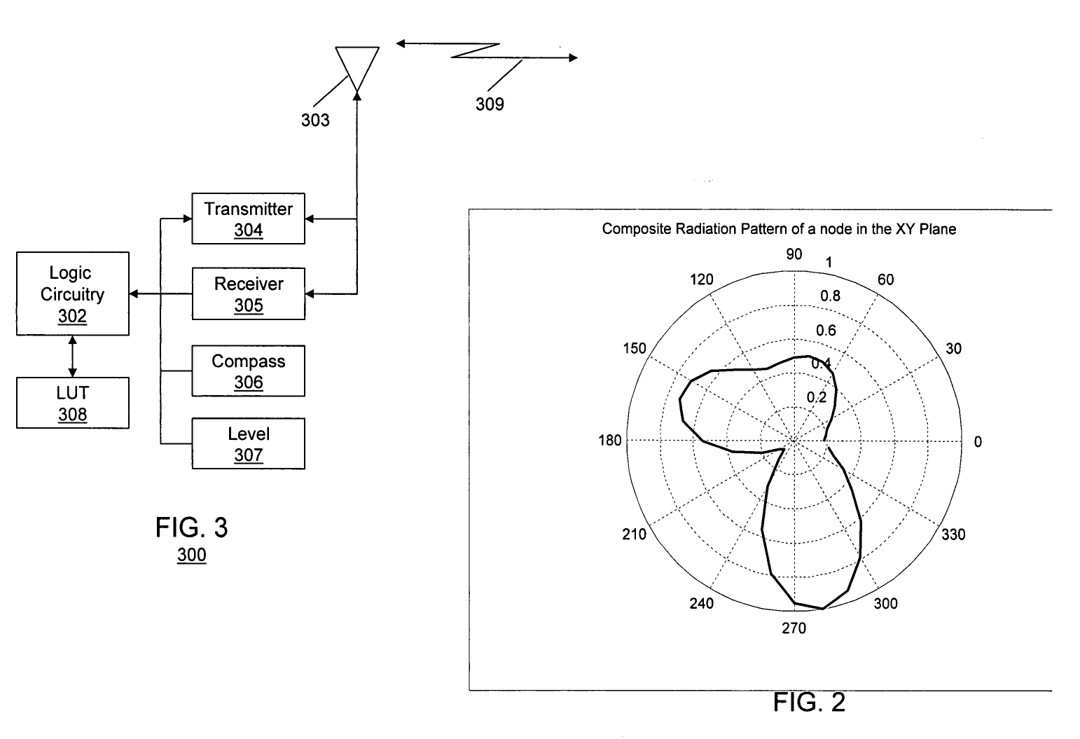

Fortunately, the composite radiation pattern of a node does not have to be unknown. It can be measured. FIG. 2 shows a polar graph of a composite radiation pattern in the XY plane of a transmitting node, as measured in an anechoic chamber of Motorola's facility in Plantation, Florida. As is evident, antenna gain for a received signal varies significantly based on azimuth angle (θ). For instance, referring to the figure, the signal strength measured at θ=275° is 20 times stronger than at θ=212°. Each node 104, 105 will have both a transmit antenna pattern and a receive antenna pattern. The transmit antenna pattern comprises a node's transmit power vs. angle, while the receive antenna pattern comprises a node's receive signal strength vs. angle.

In a three-dimensional deployment of nodes 104, 105, the transmitted signal strength and received signal sensitivity are functions of both azimuth angular orientation (θ) and tilt angle (Φ). Such a three-dimensional radiation pattern can also be determined by measurement and used to compensate signal strengths for the purpose of location estimation.

The azimuth (θ) and the tilt from horizontal (Φ) for each reference node are known a priori. It is assumed that the (x,y) coordinates, azimuth, θ, and tilt, Φ, of reference nodes 105 are recorded. Three embodiments exist to take advantage of this information and to improve upon location estimates.
In a first embodiment, the angle existing between each reference node and the blind node is taken into consideration by the blind node wishing to locate itself. Any signal strength measurement taken from the reference nodes is adjusted based on the transmit antenna patterns for each reference node.
In a second embodiment of the present invention, angle existing between each reference node and the blind node is taken into consideration by the blind node wishing to locate itself. Any signal strength measurement taken from the reference nodes is adjusted based on the receive antenna pattern for the blind node.
In a third embodiment of the present invention, angle existing between each reference node and the blind node is taken into consideration by the blind node wishing to locate itself. Any signal strength measurement taken from the reference nodes is adjusted based on both the receive antenna pattern for the blind node and the transmit antenna patterns for each reference node.

The angle between a reference node and a blind node can be determined in a number of ways. In the preferred embodiment of the present invention an integrated compass gives the absolute angle of orientation. Other methods include sweeping angles in a phased antenna array, establishing angle by using reference nodes.

FIG. 3 is a block diagram of blind node 300 equipped to determine its location via signal-strength measurements. In a preferred embodiment of the present invention blind node 300 comprises antenna 303 coupled to transmitter 304 and receiver 305, in turn, coupled to logic circuitry 302. Compass 306 is provided to determine a rotation relative to a predetermined direction and level 307 is provided to determine a tilt of the blind node's antenna. Although various forms for antenna 303, transmitter 304 and receiver 305, and logic circuitry 302 are envisioned, in a preferred embodiment of the present invention blind node 300 is formed from a Freescale Inc. MC13192 transceiver (transmitter 304 and receiver 305) coupled to a Motorola HC08 8-bit processor 302. When blind node 300 wishes to determine its location, it receives over-the-air communication signal 309 transmitted from reference nodes 105. Communication signal 309, received from participating reference nodes 105 comprises a physical location of reference node 105 (e.g., (x,y,z) components) for each reference node 105. (The physical location of each reference node 105 may be known by node 300 beforehand, with reference nodes 105 simply providing identification information). Once received by receiver 305, the physical location for each reference node 105 are determined from over-the air signal 309. Signal 309 is further analyzed to determine a signal strength between a plurality of reference nodes 105 and node 300.

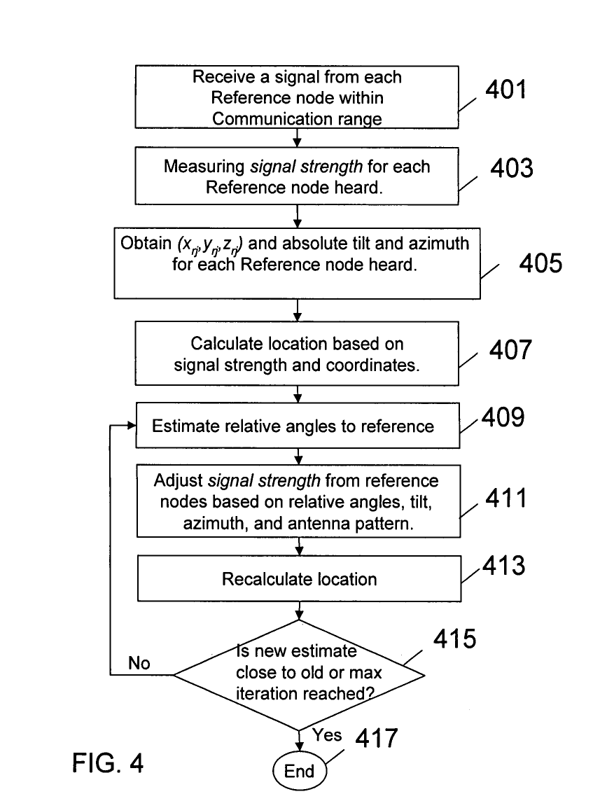

In a preferred embodiment of the present invention, a computational iterative process ensues once signal strengths are measured. This is illustrated in FIG. 4. At the outset, it is assumed that composite antenna patterns of the reference nodes, whose signals may be used in the location determination process, have been collected by the logic 302 of the blind node. At step 401 receiver 305 receives a plurality of signals from the reference (located) nodes 105 and logic circuitry 302 measures (determines) and records the strengths of the received signals 309 (step 403). At step 405 coordinates, absolute tilt, and azimuth for the reference nodes are obtained by logic circuitry 302. In the preferred embodiment of the present invention the absolute tilt comprises an inclination from the horizontal or vertical and the azimuth comprises a horizontal angular distance from a reference direction, usually the northern point of the horizon, to the point on the horizon where the antenna is pointed (measured clockwise). The horizon can be geographical or a geometrical abstraction; it is merely a means to establish a reference convention. As discussed above, this information may be present in signals 309 or may be previously known by node 300 (stored in LUT 308).

Once a sufficient number of reference nodes' information is recorded, logic circuitry 302 makes an initial estimation of the location of bold node 300, using at least the measured signal strengths (step 407). Based on at least the initial location estimation, the angles from the blind node to the reference nodes are calculated by logic circuitry 302 (step 409). The angle from the blind node to a reference node comprises a horizontal angular distance from a reference direction, usually the northern point of the horizon, to the point on the horizon where the reference node is located (measured clockwise).

At step 411 logic circuitry 302 accesses LUT 308 to determine a transmit antenna pattern for the reference nodes, and the appropriate compensation/correction to the received signal strengths from the reference nodes are made based on at least one radiation pattern. In the first embodiment of the present invention, the correction is made by determining angles from the blind node to the reference nodes, determining a transmit radiation pattern for the reference nodes, and correcting each of the plurality of signal strengths based on the transmit radiation pattern and the angles from the blind node to the located nodes. As is evident, the correction of each of the plurality of signal strengths is at least based on the transmit radiation pattern and the angles from the blind node to the located nodes, and may be based on additional elements such as the receive radiation pattern and the azimuth.

In the second embodiment of the present invention, the receive antenna pattern may is obtained from LUT 308 along with an azimuth and tilt of the blind node's antenna. The azimuth and tilt of the blind node's antenna is determined by logic circuitry 302 accessing compass 306 and level 307, respectively. The appropriate compensation/correction to the received signal is made by determining angles from the blind node to the located nodes, determining an azimuth and/or tilt for the blind node, determining a receive radiation pattern, and correcting each of the plurality of signal strengths based on the receive radiation pattern, the azimuth, and the angles from the blind node to the reference nodes.

Finally, in the third embodiment of the present invention the correction to the signal strength measurements are made by determining angles from the blind node to the located nodes, determining an azimuth and/or tilt for the blind node, determining a receive radiation pattern, determining a transmit radiation pattern for the located nodes, and correcting each of the plurality of signal strengths based on the receive radiation pattern, the transmit radiation pattern, the azimuth, and the angles from the blind node to the reference nodes.

To summarize, in the first embodiment of the present invention any signal strength measurement taken from the reference nodes is adjusted based on the transmit antenna patterns for each reference node. In the second embodiment of the present invention any signal strength measurement taken from the reference nodes is adjusted based on the receive antenna pattern of the blind node. Finally, in the third embodiment of the present invention any signal strength measurement taken from the reference nodes is adjusted based on both the receive antenna pattern of the blind node and the transmit antenna patterns of each reference node.

At step 413, the location is recalculated by logic circuitry 302 with the corrected signal strengths. Finally, at step 415 the difference between the previous location estimate and the present estimate is examined by logic circuitry 302. If the difference is satisfactorily small, the iteration process ends at step 417, otherwise the logic flow returns to step 409.

In the preferred embodiment of the present invention the determination of location based on signal strength is accomplished by associating a signal-strength measurement of each reference node's signal to a distance. Location determination by maximal likelihood estimation is then performed based on the distances to each reference node. In alternate embodiments of the present invention, the determination of location based on signal strength measurements of participating reference nodes may be done using different techniques. For example, locations may be calculated as described by Niu et al., in U.S. patent application Ser. No. 11/057874, METHOD AND APPARATUS FOR DETERMINING THE LOCATION OF A NODE IN A WIRELESS SYSTEM, or as described by Patwari et al. in U.S. Pat. No. 6,473,038 METHOD AND APPARATUS FOR LOCATION ESTIMATION.

It should be noted that in the preferred embodiment of the present invention antenna-gain patterns are stored in a database, or lookup table 308. For a blind node, the storage of antenna-gain patterns may involve a blind node requesting to download antenna patterns (or points of the antenna pattern) from reference nodes, or the reference nodes communicating or broadcasting their pattern (or points of the antenna pattern) in a beacon. The pattern may also be stored at manufacture time or from previous execution of the radiolocation algorithm. Furthermore, the pattern may be recreated mathematically from a set of parameters, rather than being stored explicitly in a table.

Finally, in all embodiments of the present invention, corrections to all signal-strength measurements are accomplished by analyzing transmit and/or receive radiation patterns and appropriately correcting the signal strength measurements based on the radiation patterns. More particularly, a LUT or mathematical function that describes the antenna pattern is applied in the blind node to scale up the received signal strength by the amount of attenuation the nodes' antenna patterns exhibit in the direction of their signals. Likewise, the received signal strength is scaled down by an appropriate amount if the patterns exhibit a gain in the direction of their signals.

While the invention has been particularly shown and described with reference to a particular embodiment, it will be understood by those skilled in the art that various changes in form and details may be made therein without departing from the spirit and scope of the invention. For example, in the above description all signal corrections and locations were being done internally within a node wishing to find its location. However, one of ordinary skill in the art will recognize that the necessary information required to locate a node may be passed to equipment 106, where location estimates can be centrally performed. It is intended that such changes come within the scope of the following claims.

1. A method for determining a location of a node in a wireless network, the method comprising the steps of:
receiving a plurality of signals from located nodes;
determining a plurality of signal strengths for the plurality of signals;
correcting the plurality of signal strengths based on at least one radiation pattern; and
locating the node based on the corrected signal strengths.

2. The method of claim 1 wherein the step of correcting the plurality of signal strengths based on at least one radiation pattern comprises the steps of:
determining angles from the blind node to the located nodes;
determining a transmit radiation pattern for the located nodes; and
correcting each of the plurality of signal strengths based on the transmit radiation pattern and the angles from the blind node to the located nodes.

3. The method of claim 2 wherein the step of determining the angles from the blind node to the located nodes comprises the step of determining horizontal angular distances from a reference direction to a point where the located node is located.

4. The method of claim 1 wherein the step of correcting the plurality of signal strengths based on at least one radiation pattern comprises the steps of:
determining angles from the blind node to the located nodes;
determining an azimuth for the blind node;
determining a receive radiation pattern; and
correcting each of the plurality of signal strengths based on the receive radiation pattern, the azimuth, and the angles from the blind node to the located nodes.

5. The method of claim 4 wherein the step of determining the angles from the blind node to the located nodes comprises the step of determining horizontal angular distances from a reference direction to a point where the located node is located.

6. The method of claim 1 wherein the step of correcting the plurality of signal strengths based on at least one radiation pattern comprises the steps of:
determining angles from the blind node to the located nodes;
determining an azimuth for the blind node;
determining a receive radiation pattern;
determining a transmit radiation pattern for the located nodes; and
correcting each of the plurality of signal strengths based on the receive radiation pattern, the transmit radiation pattern, the azimuth, and the angles from the blind node to the located nodes.

7. The method of claim 6 wherein the step of determining the angles from the blind node to the located nodes comprises the step of determining horizontal angular distances from a reference direction to a point where the located node is located.

8. A method for a blind node to locate itself, the method comprising the steps of:
receiving a plurality of signals from located nodes;
determining a plurality of signal strengths for the plurality of signals;
calculating a location of the blind node based on the signal strengths for the plurality of signals;
determining angles to the located nodes;
correcting the plurality of signal strengths based on at least one radiation pattern and the angles to the located nodes; and
recalculating the location of the blind node based on the corrected signal strengths.

9. The method of claim 8 wherein the step of correcting the plurality of signal strengths based on at least one radiation pattern comprises the steps of:
determining a transmit radiation pattern for the located nodes; and
correcting each of the plurality of signal strengths based on the transmit radiation pattern and the angles to the located nodes.

10. The method of claim 8 wherein the step of determining the angles to the located nodes comprises the step of determining horizontal angular distances from a reference direction to a point where the located node is located.

11. The method of claim 8 wherein the step of correcting the plurality of signal strengths based on at least one radiation pattern comprises the steps of:
determining an azimuth for the blind node;
determining a receive radiation pattern; and
correcting each of the plurality of signal strengths based on the receive radiation pattern, the azimuth, and the angles to the located nodes.

12. The method of claim 8 wherein the step of determining the angles to the located nodes comprises the step of determining horizontal angular distances from a reference direction to a point where the located node is located.

13. The method of claim 8 wherein the step of correcting the plurality of signal strengths based on at least one radiation pattern comprises the steps of:
determining angles to the located nodes;
determining an azimuth for the blind node;
determining a receive radiation pattern;
determining a transmit radiation pattern for the located nodes; and
correcting each of the plurality of signal strengths based on the receive radiation pattern, the transmit radiation pattern, the azimuth, and the angles from the blind node to the located nodes.

14. The method of claim 8 wherein the step of determining the angles to the located nodes comprises the step of determining horizontal angular distances from a reference direction to a point where the located node is located.

15. An apparatus comprising:
a receiver receiving a plurality of signals from located nodes;
logic circuitry determining a plurality of signal strengths for the plurality of signals, correcting the plurality of signal strengths based on at least one radiation pattern, and locating a node based on the corrected signal strengths.

16. The apparatus of claim 15 wherein the logic circuitry corrects the plurality of signal strengths by determining angles from the node to the located nodes, determining a transmit radiation pattern for the located nodes, and correcting each of the plurality of signal strengths based on the transmit radiation pattern and the angle of transmissions.

17. The apparatus of claim 16 wherein the step of determining the angles from the node to the located nodes comprises the step of determining horizontal angular distances from a reference direction to a point where the located node is located.

18. The method of claim 15 wherein the logic circuitry corrects the plurality of signal strengths by determining angles from the node to the located nodes, determining a receive radiation pattern, determining an azimuth, and correcting each of the plurality of signal strengths based on the receive radiation pattern, the azimuth, and the angle of transmissions.

19. The apparatus of claim 18 wherein the step of determining the angles from the node to the located nodes comprises the step of determining horizontal angular distances from a reference direction to a point where the located node is located.
